(19) United States
(12) Patent Application Publication
(10) Pub. No.: US 2015/0115849 A1
(43) Pub. Date: Apr. 30, 2015

(54) SYSTEM AND METHOD FOR PAUSING AND RESUMING AN OPERATION OF A MOTOR

(71) Applicant: Regal Beloit America, Inc., Beloit, WI (US)

(72) Inventor: Marc McKinzie, West Milton, OH (US)

(21) Appl. No.: 14/062,591

(22) Filed: Oct. 24, 2013

(51) Int. Cl. H02P 29/00

(52) U.S. Cl. CPC H02P 29/0011
USPC 318/162

(57) ABSTRACT

A motor controller coupled to a motor is described. The motor controller includes a computing device configured to receive a first command designating a duration during which to operate the motor. The computing device is further configured to operate the motor during a first portion of the designated duration, receive a second command to pause the operation of the motor, in response to receiving the second command, pause the operation of the motor, receive a third command to resume the operation of the motor, and in response to receiving the third command, resume the operation of the motor for a second portion of the designated duration.

### BACKGROUND

The field of the disclosure relates generally to motors, and more particularly, to systems and methods for pausing and resuming an operation of a motor.

At least some known systems for controlling the operation of a motor schedule the operation of the motor based on absolute times. More specifically, a start time and a stop time for an operation are entered and stored in a motor controller, and the motor controller causes the motor to begin operation at the start time and end operation at the stop time. Such systems include a real-time clock to determine when operation of the motor should begin and end, based on the stored schedule. Additionally, at least some such systems include a display on a user interface that is capable of displaying absolute times and one or more buttons to enable a user to enter or adjust the absolute times to specify when operation of the motor is to begin and end. The inclusion of a real-time clock and a user interface capable of enabling a user to view and adjust absolute times adds to the cost and manufacturing complexity of such systems.

Additionally, in at least some known systems that include a more simplified user interface for specifying when a motor should operate, the user interface enables a user to enter a duration for operation of the motor. For example, such a user interface may enable a user to specify that the motor should operate for 8 hours, starting when the users activates a start button on the user interface. In at least some such systems, if operation of the motor must be stopped, for example to perform a maintenance task, the user must activate a stop button, causing relative timing information to be lost. More specifically, the motor cannot resume the operation for a remainder of the specified duration. Rather, the motor is restarted from the beginning of the specified duration. Accordingly, it would be useful to have a system that enables a duration for operation of a motor to be specified in relative terms, rather than as absolute start and stop times, and that enables operation of the motor to be paused and resumed for a remainder of the specified duration.

### BRIEF DESCRIPTION

In one aspect, a motor controller coupled to a motor is provided. The motor controller includes a computing device configured to receive a first command designating a duration during which to operate the motor. The computing device is further configured to operate the motor during a first portion of the designated duration, receive a second command to pause the operation of the motor, in response to receiving the second command, pause the operation of the motor, receive a third command to resume the operation of the motor, and in response to receiving the third command, resume the operation of the motor for a second portion of the designated duration.

In another aspect, a method for pausing and resuming an operation of a motor is provided. The method includes receiving, at a computing device in a motor controller coupled to the motor, a first command designating a duration during which to operate the motor. The method additionally includes operating the motor during a first portion of the designated duration, receiving a second command to pause the operation of the motor, in response to receiving the second command, pausing operation of the motor, receiving a third command to resume the operation of the motor, and in response to receiving the third command, resuming operation of the motor for a second portion of the designated duration.

In another aspect, a computer-readable storage device having processor-executable instructions embodied thereon, for pausing and resuming an operation of a motor is provided. When executed by a computing device in a motor controller coupled to the motor, the processor-executable instructions cause the computing device to receive a first command designating a duration during which to operate the motor, operate the motor during a first portion of the designated duration, receive a second command to pause the operation of the motor, in response to receiving the second command, pause the operation of the motor, receive a third command to resume the operation of the motor, and in response to receiving the third command, resume the operation of the motor for a second portion of the designated duration.

### BRIEF DESCRIPTION OF THE DRAWINGS

FIG. 1 is a block diagram of an example system including a user interface coupled to a motor controller that is coupled to a motor that drives a pump.

FIG. 2 is a diagram of the user interface of the system of FIG. 1.

FIG. 3 is a block diagram of an example computing device that may be incorporated in the system of FIG. 1.

FIG. 4 is a flow chart of an example process that may be carried out by the motor controller of the system shown in FIG. 1.

### DETAILED DESCRIPTION

Implementations of the systems and methods described herein enable a user to temporarily stop the operation of a motor without interrupting a programmed run schedule for the motor. More specifically, in one example, a system is described herein in which a run schedule for a motor is specified as a duration (e.g., a number of hours in a 24 hour cycle), rather than as absolute start and stop times, and in which a first button that has a first function when activated a first time (e.g., starting operation of the motor) additionally has a second function of pausing operation of the motor when the first button is activated a second time. In some implementations, a pause indicator device, such as a light emitting diode (LED), illuminates to indicate that operation of the motor has been paused. By activating the first button again, the operation of the motor is resumed (unpaused). When the operation of the motor is resumed, the motor operates for the remainder of the duration, rather than starting over and operating for the entire programmed duration. When the operation of the motor is paused, the speed of the motor is zero rotations per minute (RPM), and maintenance that requires the motor to be inactive may be performed. For example, a filter in a pump coupled to the motor may be cleaned while operation of the motor is paused.

In one implementation, a computer program is provided, and the program is embodied on a computer-readable medium. In an example implementation, the system is executed on a single computing device, without requiring a connection to a sever computer. The computer program is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

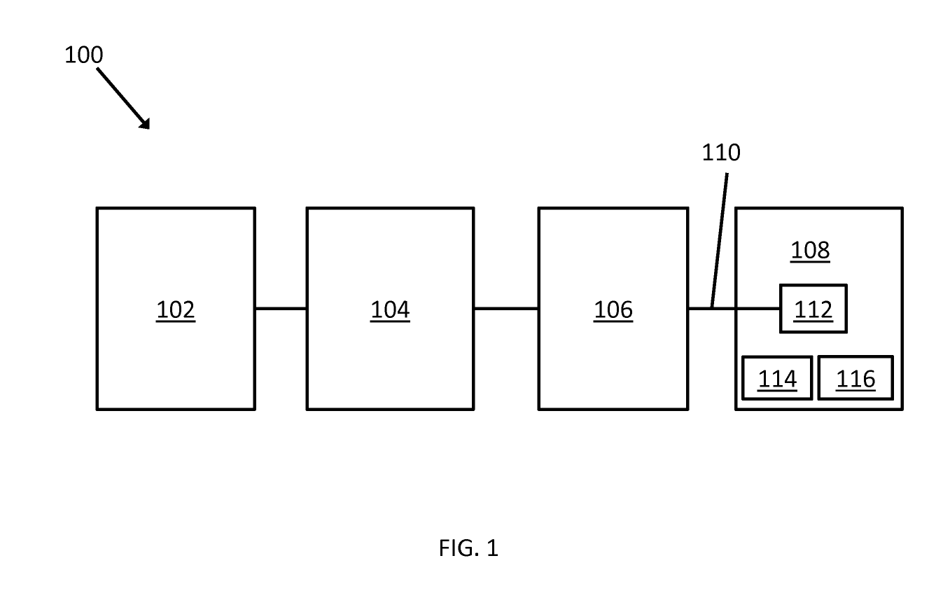

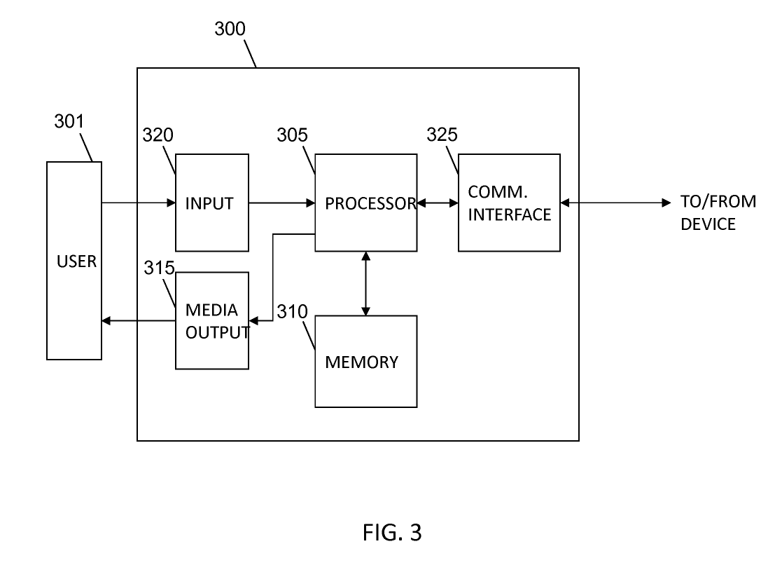

FIG. 1 is a block diagram of an example system 100 that includes a user interface 102 coupled to a motor controller 104. Motor controller 104 is coupled to a motor 106 that drives a pump 108. More specifically, motor 106 is coupled to pump 108 by a shaft 110. Shaft 110 rotates to turn an impeller 112. Pump 108 includes an inlet 114 and an outlet 116. In some implementations, system 100 is used to move liquid, such as water, in a pool, spa, or other aquatic environment. In other implementations, motor 106 drives a fan for moving air, for example in a heating, ventilation, and air conditioning (HVAC) system. Motor controller 104 is configured to operate motor 106 according to parameters stored in a memory 310 (FIG. 3) of motor controller 104. At least a portion of the parameters may be set or adjusted through user interface 102. For example, motor controller 104 may be configured to operate motor 106 for a predetermined duration at a predetermined speed. For example, motor controller 104 may be configured to operate motor for a predetermined number of hours, such as six hours, at a speed of 2100 RPM. Motor controller 104 may operate on a predetermined time cycle, such as 24 hours. Accordingly, every 24 hours, motor controller 104 may cause motor 106 to operate for six hours at 2100 RPM, according to the example parameters described above.

In some implementations, motor controller 104 may cause motor 106 to operate in a sequence of “steps” wherein each step is associated with a duration and a speed. Additionally, motor controller 104 is configured to pause or temporarily cease operation of motor 106 when motor controller 104 receives a pause command from user interface 102, such that the speed of motor 106 is reduced to 0 RPM. More specifically, when motor 106 is operating at a first speed set by motor controller 104 for a first portion of a duration, motor controller 104 may pause motor 106 by reducing the speed of motor 106 to 0 RPM. Additionally, motor controller 104 is configured to unpause or resume the operation of motor 106 when motor controller 104 subsequently receives an unpause or resume command from user interface 102, such that motor 106 operates at the first speed for a second portion (e.g., a remainder) of the duration. While motor 106 is paused, a maintenance operation may be performed on one or more components of system 100. For example, a filter (not shown) may be cleaned.

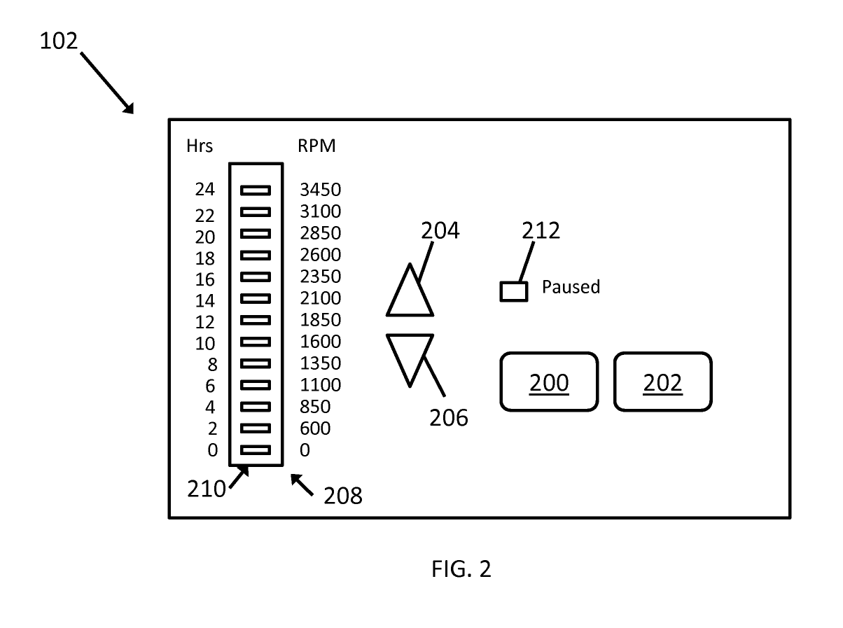

FIG. 2 is a diagram of user interface 102 of system 100. User interface 102 includes a first button 200 and a second button 202. Additionally, user interface 102 includes an increase button 204, a decrease button 206, and a duration and speed indicator 208 that includes a plurality of LEDs 210. Additionally, user interface 102 includes a pause indicator device 212. LEDs 210 of duration and speed indicator 208 illuminate to indicate a duration, specified in a number of hours, and a speed, specified in rotations per minute (RPM) for motor 106 to operate at. Increase button 204 and decrease button 206 may be activated to selectively increase and decrease the duration and speed for motor 106 to operate at. The duration and speed may be stored by motor controller 104. When first button 200 is activated, user interface 102 transmits a first command to motor controller 104 to operate motor 106 at the specified speed for the specified duration.

When first button 200 is activated after a first portion of the duration has passed, user interface 102 transmits a second command to motor controller 104 to pause the operation of motor 106. Additionally, in some implementations, pause indicator device 212 generates a visual indication that motor 106 is paused. In other implementations, pause indicator device 212 generates an audible indication that motor 106 is paused. In other implementations, pause indicator device 212 may be absent. When first button 200 is activated again, user interface 102 transmits a third command to motor controller 104 to resume operation of motor 106 at the specified speed for the remainder of the duration. However, first button 200 may be activated additional times to selectively pause and unpause motor 106 as described above. By contrast, when second button 202 is activated, user interface 102 transmits a stop command to motor controller 104 to stop operation of motor 106. Accordingly, motor controller 104 stops operation of motor 106. Unlike the pause and unpause operation described above, when motor controller 104 stops motor 106 in response to receiving the stop command, operation of motor 106 may not be resumed for a remainder of the duration. Rather, the duration is reset.

In some implementations, user interface 102 may be configured to recognize the first activation of first button 200 when first button is tapped (e.g., pressed for a first time period and then released) and to recognize the second activation (i.e., to pause motor 106) and the third activation (i.e., to unpause motor 106) when first button is pressed and held (e.g., pressed for a second time period that is longer than the first time period). In some implementations, second button 202 is absent and user interface 102 is configured to transmit a stop command to motor controller 104 when first button 200 is tapped, as distinguished from being pressed and held, when motor 106 is operating.

FIG. 3 is a block diagram of an example computing device 300 that may be incorporated in one or more components of system 100 (FIG. 1). In some implementations, portions of computing device 300 may be shared across user interface 102 and motor controller 104. Computing device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or other data, such as motor operating parameters (e.g., speeds and durations), to be stored and retrieved. Memory area 310 may include one or more computer-readable media.

Computing device 302 also includes at least one media output component 315 for presenting information to user 301. Media output component 315 is any component capable of conveying information to user 301. In some embodiments, media output component 315 includes an output adapter such as a video adapter and/or an audio adapter. An output adapter is operatively coupled to processor 305 and operatively couplable to an output device such as a display device (e.g., a liquid crystal display (LCD), one or more light emitting diodes (LED), an organic light emitting diode (OLED) display, cathode ray tube (CRT), or “electronic ink” display) or an audio output device (e.g., a speaker or headphones). In some implementations, the output device may simply include duration and speed indicator 208 (FIG. 2) and/or pause indicator device 212.

In some embodiments, computing device 302 includes an input device 320 for receiving input from user 301. Input device 320 may include, for example, first button 200 (FIG. 2), second button 202 (FIG. 2), increase button 204 (FIG. 2), decrease button 206 (FIG. 2), a keypad, a touch sensitive panel (e.g., a touch pad or a touch screen), and/or a microphone. A single component such as a touch screen may function as both an output device of media output component 315 and input device 320.

Computing device 302 may also include a communication interface 325, which is communicatively couplable to another device. For example, communication interface 325 may couple user interface 102 to motor controller 104. Additionally, communication interface 325 may couple motor controller 104 to motor 106. Communication interface 325 may include, for example, one or more conductors for transmitting electrical signals and/or power. In other implementations, communication interface 325 may additionally or alternatively include a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). Stored in memory area 310 are, for example, computer-readable instructions and data for operating user interface 102 and for operating motor 106.

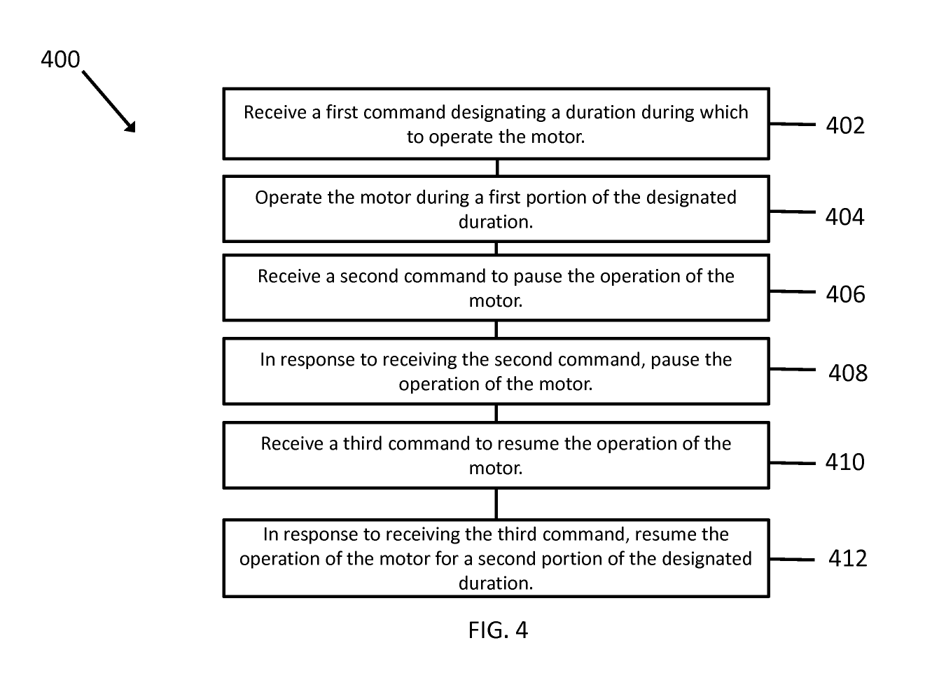

FIG. 4 is a flow chart of an example process 400 that may be carried out by motor controller 104 (FIG. 1) for pausing and resuming operation of motor 106 (FIG. 1). Initially, motor controller 104 receives 402 a first command designating a duration during which to operate motor 106. For example, user 301 (FIG. 3) may operate increase button 204 and/or decrease button 206 of user interface 102 to designate the duration during which to operate motor 106 and activate (e.g., tap) first button 200, causing user interface 102 to transmit the first command to motor control 104. In some implementations, user 301 may additionally designate a speed at which to operate motor 106 during the duration. Next, motor controller 104 operates 404 motor 106 during a first portion (e.g., 2 hours) of the designated duration. Next, motor controller 104 receives 406 a second command to pause the operation of motor 106. For example, user 301 may activate first button 200 a second time, causing user interface 102 to transmit the second command to motor controller 104. In some implementations, user interface 102 recognizes the second activation of first button 200 when user 301 presses and holds first button 200 for a predetermined period of time, such as 3 seconds. In some implementations, motor controller 104 receives the second command when a combination of buttons are activated at one time. Next, in response to receiving the second command, motor controller 104 pauses 408 operation of motor 106.

Next, motor controller 104 receives 410 a third command to resume the operation of motor 106. For example, user 301 may activate first button 200 a third time, causing user interface 102 to transmit the third command to motor controller 104. In some implementations, user interface 102 recognizes the third activation of first button 200 when user 301 presses and holds first button 200 for a predetermined period of time, such as 3 seconds. In some implementations, motor controller 104 receives the third command when a combination of buttons are activated at one time. In response to receiving the third command, motor controller 104 resumes 412 operation of motor 106 for a second portion (e.g., the remainder) of the designated duration. Process 400 is described above as being performed by motor controller 104. More specifically, however, computing device 300, included in motor controller 104, carries out process 400. As described with reference to FIG. 3, in some implementations, portions of computing device 300 may be shared between motor controller 104 and user interface 102, such that computing device 300 carries out operations described as being performed by user interface 102 as well as operations described as being performed by motor controller 104.

The methods and systems described herein may be implemented using computer programming or engineering techniques including computer software, firmware, hardware or any combination or subset thereof, wherein the technical effect may include at least one of: (a) receiving a first command designating a duration during which to operate a motor; (b) operating the motor during a first portion of the designated duration; (c) receiving a second command to pause an operation of the motor; (d) in response to receiving the second command, pausing the operation of the motor; (e) receiving a third command to resume the operation of the motor; and (f) in response to receiving the third command, resuming the operation of the motor for a second portion of the designated duration.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 305, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

As compared to known systems and methods for controlling the operation of a motor, the systems and methods described herein enable operating a motor for a first portion of a predetermined duration, pausing the operation of the motor, and resuming the operation of the motor for a second portion of the predetermined duration. Accordingly, the operation of the motor may be temporarily suspended to enable maintenance to be performed, without altogether cancelling (i.e., stopping) the operation of the motor and/or schedule.

Exemplary embodiments of systems and methods for pausing and resuming the operation of a motor are described above in detail. The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A motor controller coupled to a motor, said motor controller comprising:
a computing device configured to:
receive a first command designating a duration during which to operate the motor;
operate the motor during a first portion of the designated duration;
receive a second command to pause the operation of the motor;
in response to receiving the second command, pause the operation of the motor;
receive a third command to resume the operation of the motor; and
in response to receiving the third command, resume the operation of the motor for a second portion of the designated duration.

2. The motor controller of claim 1, wherein said computing device is coupled to a user interface comprising a first button, and wherein said computing device is further configured to:
receive the first command by detecting a first activation of the first button;
receive the second command by detecting a second activation of the first button; and
receive the third command by detecting a third activation of the first button.

3. The motor controller of claim 1, wherein said computing device is coupled to a pause indicator device, and wherein said computing device is further configured to generate an indication, through the pause indicator device, that the operation has been paused.

4. The motor controller of claim 3, wherein said computing device is further configured to cause the pause indicator device to generate a visual indication that the operation has been paused.

5. The motor controller of claim 3, wherein said computing device is further configured to cause the pause indicator device to generate an audible indication that the operation has been paused.

6. The motor controller of claim 1, wherein said computing device is further configured to resume the operation of the motor for a second portion of the designated duration by resuming operation of the motor for a remainder of the designated duration.

7. The motor controller of claim 1, wherein said computing device is further configured to receive the second command by detecting that the first button has been pressed and held for a predetermined length of time.

8. A method for pausing and resuming an operation of a motor, said method comprising:
receiving, at a computing device in a motor controller coupled to the motor, a first command designating a duration during which to operate the motor;
operating the motor during a first portion of the designated duration;
receiving a second command to pause the operation of the motor;
in response to receiving the second command, pausing operation of the motor;
receiving a third command to resume the operation of the motor; and
in response to receiving the third command, resuming operation of the motor for a second portion of the designated duration.

9. The method of claim 8, wherein the computing device is coupled to a user interface including a first button, and wherein:
said receiving the first command further comprises detecting a first activation of the first button;
said receiving the second command further comprises detecting a second activation of the first button; and
said receiving the third command further comprises detecting a third activation of the first button.

10. The method of claim 8, wherein said computing device is coupled to a pause indicator device, said method further comprising generating an indication, through the pause indicator device, that the operation has been paused.

11. The method of claim 10, wherein said generating the indication further comprises generating a visual indication.

12. The method of claim 10, wherein said generating the indication further comprises generating an audible indication.

13. The method of claim 8, wherein said resuming operation of the motor for a second portion further comprises resuming operation of the motor for a remainder of the designated duration.

14. The method of claim 8, wherein said receiving the second command further comprises detecting that the first button has been pressed and held for a predetermined length of time.

15. A computer-readable storage device having processor-executable instructions embodied thereon, for pausing and resuming an operation of a motor, wherein when executed by a computing device in a motor controller coupled to a motor, the processor-executable instructions cause the computing device to:
receive a first command designating a duration during which to operate the motor;
operate the motor during a first portion of the designated duration;
receive a second command to pause the operation of the motor;
in response to receiving the second command, pause the operation of the motor;
receive a third command to resume the operation of the motor; and
in response to receiving the third command, resume the operation of the motor for a second portion of the designated duration.

16. The computer-readable storage device of claim 15, wherein the computing device is coupled to a user interface comprising a first button, and wherein said processor-executable instructions further cause the computing device to:
receive the first command by detecting a first activation of the first button;
receive the second command by detecting a second activation of the first button; and
receive the third command by detecting a third activation of the first button.

17. The computer-readable storage device of claim 15, wherein the computing device is coupled to a pause indicator device, and wherein said processor-executable instructions further cause the computing device to generate an indication, through the pause indicator device, that the operation has been paused.

18. The computer-readable storage device of claim 17, wherein said processor-executable instructions further cause the computing device to cause the pause indicator device to generate a visual indication that the operation has been paused.

19. The computer-readable storage device of claim 17, wherein said processor-executable instructions further cause the computing device to cause the pause indicator device to generate an audible indication that the operation has been paused.

20. The computer-readable storage device of claim 15, wherein said processor-executable instructions further cause the computing device to resume the operation of the motor for a second portion of the designated duration by resuming operation of the motor for a remainder of the designated duration.
